(19) United States
(12) Patent Application Publication
(10) Pub. No.: US 2022/0345396 A1
(43) Pub. Date: Oct. 27, 2022

(54) INFORMATION PROCESSING APPARATUS, PACKET GENERATION METHOD, SYSTEM, AND PROGRAM

(71) Applicant: NEC Corporation, Minato-ku, Tokyo (JP)

(72) Inventor: Anan SAWABE, Tokyo (JP)

(73) Assignee: NEC Corporation, Minato-ku, Tokyo (JP)

(21) Appl. No.: 17/640,570

(22) PCT Filed: Jul. 21, 2020
(86) PCT No.: PCT/JP2020/028191

§ 371 Date: Mar. 4, 2022

(30) Foreign Application Priority Data
Sep. 17, 2019 (JP) 2019-168014

(51) Int. Cl. H04L 45/00; H04L 45/02; H04L 45/48

(52) U.S. Cl. CPC H04L 45/26; H04L 45/08; H04L 45/48

(57) ABSTRACT

In order to provide an information processing apparatus that easily finds a network configuration corresponding to characteristics of a terminal to be connected, the information processing apparatus includes a model generation section and a specifying section, the model generation section being configured to generate a traffic pattern generation model, based on learning of a traffic pattern of a terminal, and the specifying section being configured to specify traffic for an output of the traffic pattern generation model, based on virtual traffic in the traffic pattern generation model. The information processing apparatus may further include a packet generation section configured to generate a packet, based on the specified traffic.

### BACKGROUND

### Technical Field

The present invention relates to an information processing apparatus, a packet generation method, a system, and a program.

### Background Art

Recent years have seen a wide spread of Long Term Evolution (LTE)/Evolved Packet Core (EPC) specified by the Third Generation Partnership Project (3GPP), as mobile network systems.

In a mobile network system as LTE described above, normally, a telecommunications operator (carrier) constructs and manages a base station, a core network, and the like to provide radio connection to users. In other words, a mobile communication operator called a mobile network operator (MNO) constructs a communication channel network to provide communication services. In addition to this, communication services by a mobile virtual network operator (MVNO) that rents a communication network from an MNO are also provided widely in recent years.

Furthermore, corporations and the like have started construction of their own mobile radio communication networks (referred to simply as “radio communication networks” below) without using any MNO or MNVO described above. In other words, construction of radio communication networks called private LTE is underway. Particularly expected is application of private LTE to the use of installing a camera in a factory or the like to monitor a state in the factory and the use of attaching a sensor to a machine tool, construction machinery or the like to control the tool and machinery.

PTL 1 describes that the technique reduces erroneous estimation and increases estimation accuracy in estimating a state of an application from communication traffic.

### CITATION LIST

### Patent Literature

[PTL 1] WO 2019/082965

### SUMMARY

### Technical Problem

As described above, it is expected to reduce, by the use of a private radio network (private LTE), the cost in a case of connecting Internet of Things (IoT) devices, such as a camera and a sensor, and a server in a network. However, construction of a private radio network is not easy for a business operator having little knowledge related to radio communication technologies.

For example, it is difficult for the business operator to determine a network configuration while taking into account of characteristics of each IoT device. A wide variety of IoT devices are connected to a radio network. For example, devices such as a camera, a sensor, and a robot are possibly connected to a radio network. Furthermore, even though IoT devices are of the same kind, when the environment in which the IoT device is installed differs for each IoT device, traffic flowing from the IoT device to a network also differs for each IoT device.

It is necessary for a business operator making use of IoT devices to determine an optimal network configuration while taking into account of traffic differing for each IoT device. Specifically, unless traffic to occur from each IoT device is estimated in advance to configure a network system that can handle the estimated traffic, network performance expected by the business operator fails to be ensured, which causes a trouble. Conversely, if a network system that can handle the estimated traffic is constructed with a sufficient margin, this causes an increase in cost and the like.

A main example object of the present invention is to provide an information processing apparatus, a packet generation method, a system, and a program that contribute to easy finding of a network configuration according to characteristics of a terminal to be connected.

### Solution to Problem

According to a first example aspect, there is provided an information processing apparatus including: a model generation section configured to generate a traffic pattern generation model, based on learning of a traffic pattern of a terminal; and a specifying section configured to specify traffic for an output of the traffic pattern generation model, based on virtual traffic in the traffic pattern generation model.

According to a second example aspect, there is provided a packet generation method in an information processing apparatus, the packet generation method including: generating a traffic pattern generation model, based on learning of a traffic pattern of a terminal; and specifying traffic for an output of the traffic pattern generation model, based on virtual traffic in the traffic pattern generation model.

According to a third example aspect, there is provided a system including: a model means for generating a traffic pattern generation model, based on learning of a traffic pattern of a terminal; and a specifying means for specifying traffic for an output of the traffic pattern generation model, based on virtual traffic in the traffic pattern generation model.

According to a fourth example aspect, there is provided a program for causing a computer installed in an information processing apparatus to execute: processing for performing learning of a traffic pattern of a terminal to generate a traffic pattern generation model reproducing the traffic pattern; and processing for generating, based on the traffic pattern generation model, a virtual packet for simulating packet forwarding of a packet transmitted from the terminal in a network.

### Advantageous Effects of Invention

According to each example aspect of the present invention, it is possible to provide an information processing apparatus, a packet generation method, a system, and a program that contribute to easy finding of a network configuration according to the characteristics of a terminal to be connected. Note that, according to the present invention, instead of or together with the above effects, other effects may be exerted.

### BRIEF DESCRIPTION OF THE DRAWINGS

FIG. 1 is a diagram for describing an overview of an example embodiment;

FIG. 2 is a flowchart illustrating an example of operations of an information processing apparatus according to an example embodiment;

FIG. 3 is a diagram for describing operations of an information processing apparatus according to a first example embodiment;

FIG. 4 is a diagram illustrating an example of a processing configuration of the information processing apparatus according to the first example embodiment;

FIG. 5A is a diagram illustrating an example of learning target information stored in a storage section of the information processing apparatus;

FIG. 5B is a diagram illustrating an example of the learning target information stored in the storage section of the information processing apparatus;

FIG. 5C is a diagram illustrating an example of the learning target information stored in the storage section of the information processing apparatus;

FIG. 6A is a diagram illustrating an example of a traffic pattern;

FIG. 6B is a diagram illustrating an example of the traffic pattern;

FIG. 7 is information illustrating an example of traffic pattern generation model management information;

FIG. 8 is a diagram illustrating an example of a network configuration handled by the information processing apparatus;

FIG. 9 is a diagram illustrating an example of a graphical user interface (GUI) displayed by the information processing apparatus;

FIG. 10 is a diagram illustrating an example of a tree structure for managing the network configuration;

FIG. 11 is a diagram illustrating an example of the GUI displayed by the information processing apparatus;

FIG. 12 is a diagram illustrating an example of a detailed network node information;

FIG. 13 is a diagram for describing assignment of simulation sections to the tree structure;

FIG. 14 is a diagram illustrating an example of an inner configuration of a transmission section according to the first example embodiment;

FIG. 15 is a flowchart illustrating an example of operations of the information processing apparatus according to the first example embodiment in a learning mode;

FIG. 16 is a flowchart illustrating an example of operations of the information processing apparatus according to the first example embodiment in a simulation mode;

FIG. 17 is a diagram illustrating an example of a processing configuration of an information processing apparatus according to a second example embodiment;

FIG. 18 is a diagram for describing arrangement of a link simulation section of the information processing apparatus according to the second example embodiment;

FIG. 19 is a diagram illustrating an example of a processing configuration of an information processing apparatus according to a third example embodiment;

FIG. 20 is a diagram illustrating an example of the GUI displayed by the information processing apparatus according to the third example embodiment;

FIG. 21 is a diagram for describing operations of the information processing apparatus according to the third example embodiment;

FIG. 22A is a diagram for describing operations of the information processing apparatus according to the third example embodiment;

FIG. 22B is a diagram for describing the operations of the information processing apparatus according to the third example embodiment;

FIG. 23 is a flowchart illustrating an example of operations of the information processing apparatus according to the third example embodiment;

FIG. 24 is a diagram for describing operations of a system according to a fourth example embodiment;

FIG. 25 is a diagram for describing operations of a system according to a fifth example embodiment; and

FIG. 26 is a diagram illustrating an example of a hardware configuration of an information processing apparatus.

### DESCRIPTION OF THE EXAMPLE EMBODIMENTS

First of all, an overview of an example embodiment will be described. Note that reference signs in the drawings provided in the overview are for the sake of convenience for each element as an example to promote better understanding, and description of the overview is not to impose any limitations. Note that, in the Specification and drawings, elements to which similar descriptions are applicable are denoted by the same reference signs, and overlapping descriptions may hence be omitted.

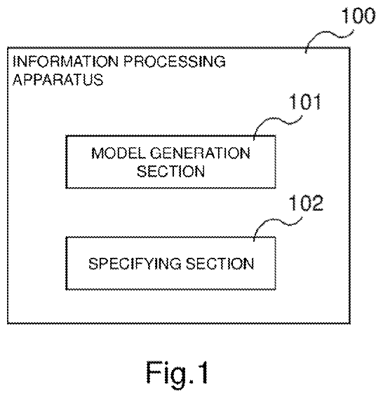

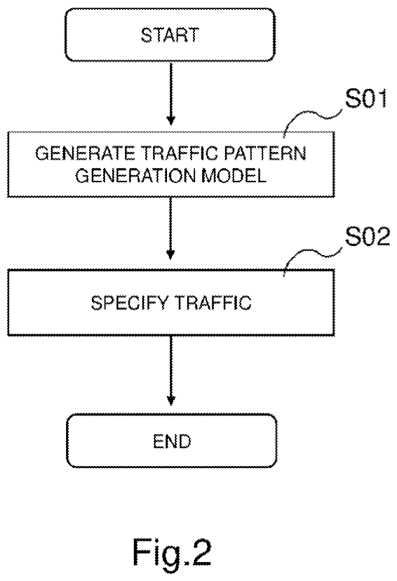

An information processing apparatus 100 according to an example embodiment includes a model generation section 101 and a specifying section 102 (see FIG. 1). The model generation section 101 generates a traffic pattern generation model, based on learning of a traffic pattern of a terminal (step S01 in FIG. 2). The specifying section 102 specifies traffic for an output of the traffic pattern generation model, based on virtual traffic in the traffic pattern generation model (step S02 in FIG. 2). Note that, although FIG. 1 illustrates the model generation section 101 and the specifying section 120 as different modules, the functions of these modules may be implemented by the same module (processing means).

The information processing apparatus 100 performs learning of the traffic pattern of the terminal in various situations and environments where the terminal is assumed to be used. Through the learning, a traffic pattern generation model is generated according to the characteristics of the terminal (device) connected to a network. The information processing apparatus 10 uses the traffic pattern generation model to simulate packet forwarding in the network, and this enables verification of the performance of the target network. Specifically, the traffic pattern generation model generated by the information processing apparatus 100 generates virtual traffic, which is a set of virtual packets. The virtual traffic reproduces the characteristics of traffic output from the terminal, the traffic served as the source of the learning. Hence, using the traffic pattern generation model for the simulation of the network allows specifying of traffic assumed to occur when the terminal is included in the network. An administrator or the like performs simulation while appropriately changing the configuration of the network, the number of terminals to be connected, and the like, and can thus easily find a network corresponding to the characteristics of a terminal to be connected.

Specific example embodiments will be described below in further detail with reference to the drawings.

### First Example Embodiment

The first example embodiment will be described in further detail with reference to the drawings.

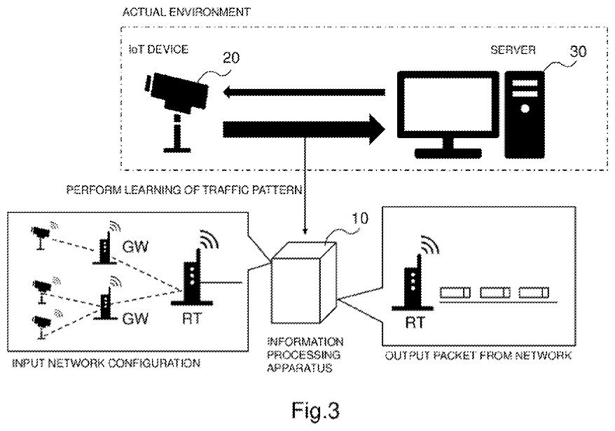

FIG. 3 is a diagram for describing operations of an information processing apparatus 10 according to a first example embodiment.

The information processing apparatus 10 operates in two operation modes.

A first operation mode is a mode of observing packets transmitted and/or received between an IoT device 20 and a server 30 in a network and learning a pattern of traffic (traffic pattern) from the traffic between the IoT device 20 and the server 30.

Examples of the traffic pattern obtained from the traffic flowing in the network include waveforms of throughput, packet size, packet transmission interval, and the like. In the first example embodiment, a description will be given by assuming that the traffic pattern obtained from the traffic flowing in the network is a waveform related to throughput. However, this does not intend to limit the traffic to which the disclosure of the present application is applicable, to that based on throughput, and target traffic may be that based on another feature (such as packet size or packet transmission interval).

In the learning mode, the information processing apparatus 10 obtains packets transmitted from the IoT device 20 installed in a site (actual environment) such as a factory, to the server 30 in the network (packets transmitted in the uplink).

In a case where the IoT device 20 is a device capable of establishing a radio connection, the information processing apparatus 10 captures frames (radio signals) sent out from the device. In contrast, in a case where the IoT device 20 is a device connected with wire to a relay apparatus such as a hub, the information processing apparatus 10 obtains packets flowing from a mirror port of the relay apparatus in the network. In the disclosure of the present application, a description is given by referring each frame or packet sent out from the IoT device 20 to as a “packet”.

The information processing apparatus 10 generates a model for reproducing a traffic pattern sent out from the IoT device to the network, based on the packets thus captured. Specifically, the information processing apparatus 10 models the traffic pattern by using a hierarchical hidden Markov model, to generate a “traffic pattern generation model”. The traffic pattern generation model obtained through the modeling by using the hidden Markov model is a stochastic state transition model and stochastically describes a change in state (for example, from packet transmission to packet transmission stop).

For various IoT devices 20 used in actual environments, the information processing apparatus 10 performs learning of the pattern of traffic flowing from a number of the IoT devices 20 installed in various environments (different places and different time periods) to the network. Each IoT device 20 being a learning target and a corresponding traffic pattern generation model are associated with each other by a “label”. Note that details of traffic pattern generation models and labels for managing the models will be described later.

Here, regarding packets transmitted and/or received between each IoT device 20 and the server 30, the number of packets transmitted in the uplink is normally greater than the number of packets transmitted in the downlink. In view of this, in the first example embodiment, packets in the uplink, having a great influence to the network configuration, are subject to learning. Note that such measures are based on the assumption that each IoT device 20 is a camera, a sensor, or the like installed in a factory or the like, but packets in the downlink may be subject to learning depending on the usage, environment, and the like of the IoT device 20. Alternatively, packets in the uplink and packets in the downlink may be subject to learning.

A second operation mode is a mode of using the traffic pattern generation model generated in the learning mode, to simulate packet forwarding in the network in which the use of the IoT device 20 is assumed. Specifically, the information processing apparatus 10 receives, from an operator or the like, an input indicating a network configuration to be verified.

For example, the operator inputs, to the information processing apparatus 10, the number of apparatuses (for example, IoT gateways and an edge router (referred to simply as a router below)) configuring a network system, connection between apparatuses, and information (the kinds, the number, and the like) related to the IoT devices 20 to be used. In the example in FIG. 3, a configuration of a network system consisting of three IoT devices, two IoT gateways (Gate Way, GWs), and one router (RT) is input to the information processing apparatus 10.

The information processing apparatus 10 virtually creates a packet generated by each IoT device in the network system thus obtained, by using a traffic pattern generation model generated in the learning mode. In other words, the information processing apparatus 10 virtually creates a packet to be transmitted from the IoT device 20 placed in an actual environment, and inputs the virtually created packet, to a network apparatus (the corresponding IoT gateway in the example in FIG. 3).

The information processing apparatus 10 forwards, from the network apparatus that has received the virtually created packet (referred to as a virtual packet below), the virtual packet to the network apparatus in the subsequent stage (the router in the example in FIG. 3).

The information processing apparatus 10 also forwards the received packet for the network apparatus in the subsequent stage (router).

The information processing apparatus 10 treats, as a packet to be transmitted from the network system, a packet generated from the network apparatus in the last stage (a virtual packet forwarded in the network system) and transmits the packet to an external apparatus. For example, the information processing apparatus 10 may output the generated packet, to a display apparatus (not illustrated in FIG. 3).

The display apparatus displays a video expressing a state in which the packets obtained from the information processing apparatus 10 are output from the network, for example. Alternatively, either one of the information processing apparatus 10 and the display apparatus may analyze the packets output from the network, and the display apparatus may display the result of the analysis. For example, the display apparatus may display statistical information indicating the performance and/or the state of the network, such as throughput, packet arrival interval, or average packet size. Alternatively, the display apparatus may display a graph or the like indicating the temporal transition of the statistical information.

The information processing apparatus 10 may output the generated packet to an actual network. For example, in the example in FIG. 3, the information processing apparatus 10 may transmit, as an “actual packet”, the generated packet to a network to which the router included in the network configuration input from the operator is connected.

The operation modes (the learning mode and the simulation mode) of the information processing apparatus 10 may be switched explicitly by the operator. Alternatively, functions of the learning mode and functions of the simulation mode may be separated to implement the information processing apparatus 10 described in the first example embodiment, by using two information processing apparatuses (computers). In this case, it is only required for the two computers to exchange necessary pieces of information (for example, a traffic pattern generation model and the like).

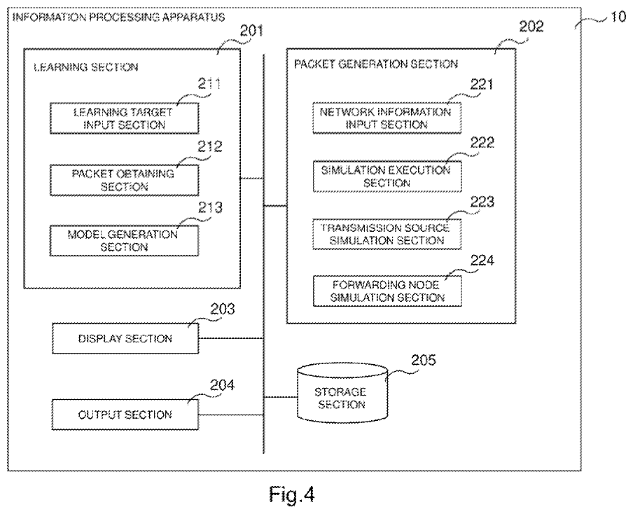

FIG. 4 is a diagram illustrating an example of a processing configuration (processing modules) of the information processing apparatus 10 according to the first example embodiment. With reference to FIG. 4, the information processing apparatus 10 includes a learning section 201, a packet generation section 202, a display section 203, an output section 204, and a storage section 205.

The learning section 201 is a processing module that operates in the learning mode. The learning section 201 includes a learning target input section 211, a packet obtaining section 212, and a model generation section 213.

The learning target input section 211 is means for receiving an input of information related to the IoT device 20 subject to learning.

The information related to the learning-target IoT device 20 includes information related to the kind of the learning-target IoT device 20, information specifying the IoT device 20, information indicating the operation environment of the IoT device 20.

The information related to the kind of the learning-target IoT device 20 may be, for example, the product name, the model name, and/or the like of the IoT device 20.

The information specifying the learning-target IoT device is, for example, information indicating the Internet Protocol (IP) address, the media access control (MAC) address, and/or the like.

Here, even if the IoT devices 20 are of the same model, the traffic patterns of the IoT devices 20 sent out to a network may differ in some situations where the IoT devices 20 are placed in the actual environment. For example, in a case where the IoT devices 20 are cameras, compressed images are transmitted from each of the cameras to the server 30, and hence traffic patterns may differ in some situations where the IoT devices 20 are installed.

In the first example embodiment, based on the information indicating the operation environment of the IoT device 20, the environment and the situation (the so-called context) in which the IoT device 20 is placed are identified. For example, given as examples as the information indicating the operation environment of the IoT device 20 are information identifying the place where the IoT device 20 is installed and the time period (daytime, night, or the like) in which the IoT device 20 operates.

The learning target input section 211 inputs at least the three kinds of information as information related to the learning-target IoT device 20. For example, the learning target input section 211 may obtain the information from an external storage apparatus such as a universal serial bus (USB) memory storing therein the information. The learning target input section 211 may access a database server or the like in the network to obtain the information.

The learning target input section 211 may generate information related to a graphical user interface (GUI) for an operating person to input the information and display the information on a liquid crystal monitor or the like via the display section 203. The learning target input section 211 may communicate with the IoT device 20 to obtain an identifier (the IP address or the like) of the IoT device 20 and obtain the information indicating the kind and operation environment of the IoT device 20 from the operator.

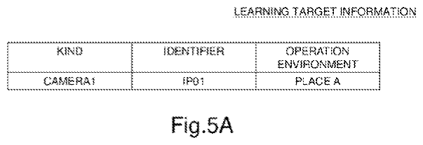

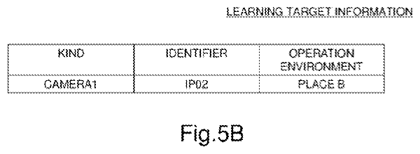

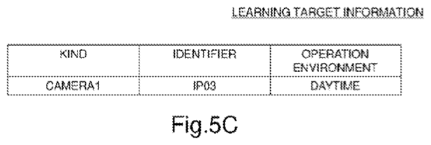

The learning target input section 211 stores the three kinds of information (the kind, the identifier, and the operation environment of the IoT device 20) in the storage section 205 as pieces of “learning target information” (see FIGS. 5A to 5C). For example, in a case where the IoT device 20 being Camera 1 that is installed in a place A and has an IP address of “IP01” is a learning target, information indicated in FIG. 5A is input to the information processing apparatus 10 and is stored in the storage section 205.

In a case where the IoT device 20 being Camera 1 that is installed in a place B and has an IP address of “IP02” is a learning target, information indicated in FIG. 5B is input to the information processing apparatus 10 and is stored in the storage section 205.

Alternatively, in a case where the IoT device 20 being Camera 1 that operates during the daytime and has an IP address of “IP03” is a learning target, information indicated in FIG. 5C is input to the information processing apparatus 10 and is stored in the storage section 205. Note that, in FIG. 5C, the time period in which the IoT device 20 operates is described as “daytime”, but a concrete time period is specified in actual.

In FIGS. 5A to 5C, examples in which any of the elements including “place” and “time period” is described as information related to the “operation environment” are illustrated. However, other elements (for example, the outdoor temperature and the like) may be used. Alternatively, a combination of a plurality of elements (for example, during the daytime in the place A or the like) may be specified as the operation environment.

As described above, the IoT devices 20 differ in traffic pattern depending on the environments in which the IoT devices 20 are placed and the like. Hence, it is desirable to obtain packets under the situation and/or environment where the actual use of each IoT device 20 is assumed. For example, FIGS. 5A and 5B illustrate that the IoT devices 20 each being Camera 1 are installed in the place A and the place B, and learning of the traffic patterns is performed. However, it is desirable to that Camera 1 of the same model be also installed in a place C to perform learning of the traffic pattern.

Note that, in the input of learning target information as those illustrated in FIGS. 5A to 5C, pieces of information may be individually input, or a plurality of pieces of information may be input together.

The packet obtaining section 212 obtains packets (frames) transmitted from the IoT devices 20. The packet obtaining section 212 passes the obtained packets to the model generation section 213.

The model generation section 213 is means for learning the traffic pattern of a terminal (IoT device 20) to thereby generate a traffic pattern generation model that reproduces the traffic pattern. In other words, the model generation section 213 generates a traffic pattern generation model obtained by modeling the traffic pattern of the learning-target IoT device 20.

The model generation section 213 refers to the learning target information stored in the storage section 205 to obtain the identifier of the learning-target IoT device 20. The model generation section 213 refers to the header of each of the packets obtained from the packet obtaining section 212, to extract packets transmitted from the learning-target IoT device 20.

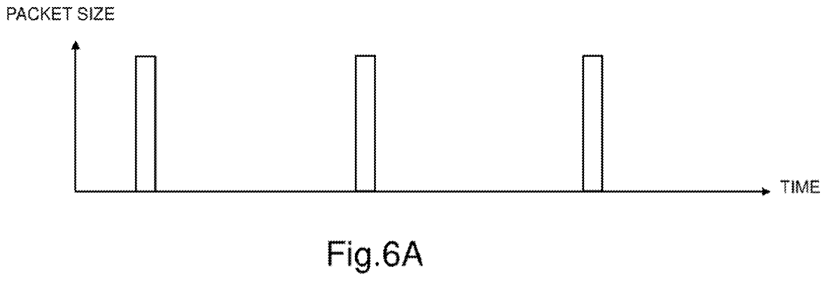

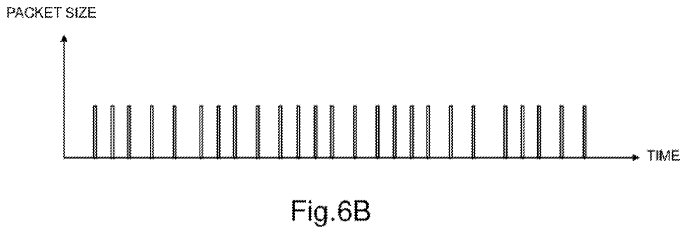

For example, the model generation section 213 extracts packets each having, as the transmission source IP address, the IP address described in the learning target information among the obtained packets. The model generation section 213 generates a traffic pattern from time-series data of the extracted packets. Specifically, the model generation section 213 generates a traffic pattern (time-series traffic) with a configuration having a reception time of each extracted packet in the horizontal axis and a packet size of each extracted packet in the vertical axis (see FIGS. 6A and 6B).

As described above, the model generation section 213 divides the traffic flowing in the network into five tuples (the transmission source/destination IP addresses, the transmission source/destination port numbers, and the protocol) and extracts a traffic pattern on a traffic flow by traffic flow basis. Note that each traffic flow is configured of a group of packets having the same information (transmission source IP address and port number as well as destination IP address and port number) as their headers.

The model generation section 213 models the extracted traffic pattern by using the hierarchical hidden Markov model, to generate a “traffic pattern generation model”. Note that a technique of applying the hierarchical hidden Markov model to a traffic pattern obtained from a network for modeling is described in PTL 1. Hence, a detailed description related to generation of a traffic pattern generation model is omitted in the disclosure of the present application. The model is generated as follows in a broad sense.

The model generation section 213 estimates state sequences, based on the hierarchical hidden Markov model of time-series data of communication traffic (traffic pattern). Subsequently, the model generation section 213 treats similar patterns from the state sequences together as a single state (grouped in a single group). The model generation section 213 thereafter extracts a state sequence (that is, a traffic pattern generation model).

For example, consider a case where traffic patterns as those illustrated in FIGS. 6A and 6B are extracted. In this case, the model generation section 213 generates each of a traffic pattern generation model that reproduces the traffic pattern illustrated in FIG. 6A and a traffic pattern generation model that reproduces the traffic pattern illustrated in FIG. 6B. In response to input of a random number (any seed value) to each of the generated traffic pattern generation models, a feature (packet size) that reproduces the corresponding traffic pattern according to a stochastic state transition model is output.

In the example in FIG. 6A, generated is such a traffic pattern generation model as to generate a packet of a large size in a case where a packet is output although the probability that a packet is output is low. In contrast, in the example in FIG. 6B, generated is such a traffic pattern generation model as to generate a packet of a small size where the probability that a packet is output is high.

The model generation section 213 associates the generated traffic pattern generation model with the “kind” and the “operation environment” included in the learning target information referred to at the time of the generation of the model, to thereby generate “traffic pattern generation model management information”.

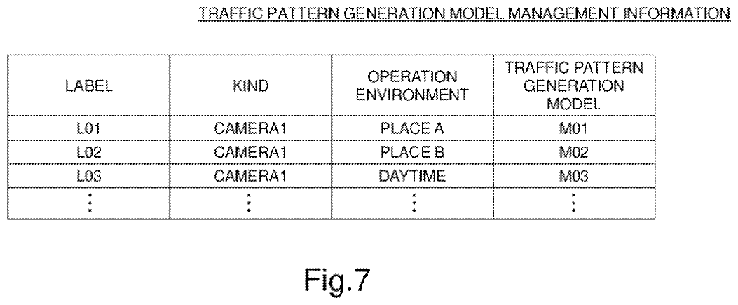

The model generation section 213 manages the set of the three kinds of information (the traffic pattern generation model, the kind, and the operation environment) as a label, and stores the information to which the label is assigned, in the storage section 205 (see FIG. 7).

The traffic pattern generation model generated by the learning section 201 has a reversible property. Specifically, when a traffic pattern generation model obtained through learning of a traffic pattern is called by using a label specifying the model, such a feature (packet size) as to reproduce a traffic pattern having served as the source of the learning is output stochastically.

The description is turned back to FIG. 4. The packet generation section 202 is a processing module that operates in the simulation mode. The packet generation section 202 includes a network information input section 221, a simulation execution section 222, a transmission source simulation section 223, and a forwarding node simulation section 224.

The network information input section 221 is means for receiving inputs related to the configuration of a network subject to simulation and information related to each node included in the network.

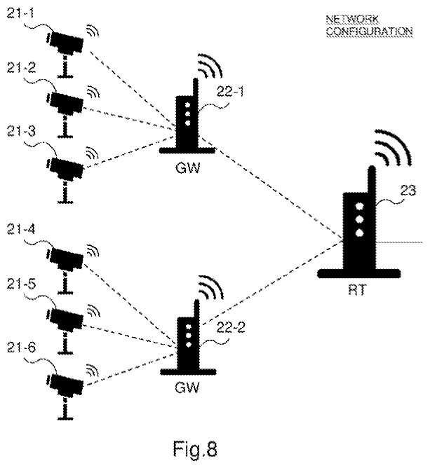

The network information input section 221 receives, as an input, for example, information related to the network illustrated in FIG. 8. The network information input section 221 may obtain information defining the network configuration, from an external storage apparatus such as a USB memory or the like. The network information input section 221 may obtain the information and/or the like from an external database server or the like.

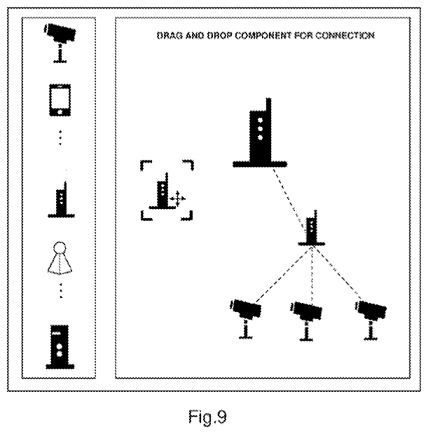

Alternatively, the network information input section 221 may generate information related to a graphical user interface (GUI) for an operating person to input the network configuration and display the information on the liquid crystal monitor or the like via the display section 203. For example, the network information input section 221 may generate information related to GUI as that illustrated in FIG. 9.

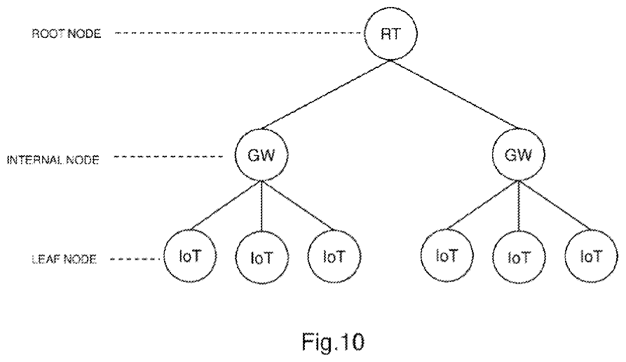

The network information input section 221 manages the obtained configuration of the network, by using a hierarchical data structure. For example, the network information input section 221 manages the obtained configuration of the network, by using a tree structure. In the example illustrated in FIG. 8, the configuration of the network is managed by a tree structure as that illustrated in FIG. 10.

With reference to FIG. 10, a router 23 corresponding to the exit of the network is managed as a root node (a node having no parent node). Each IoT device 21 in the terminal layer is managed as a leaf node (a node having no child node). Each gateway 22 located in the middle of the network is managed as an internal node (a node having a parent node and a child node(s)).

The data structure for managing the configuration of the network is not limited to a tree structure. The configuration of the network may be managed by using another data structure, for example, a data structure using a list or the like.

The network information input section 221 receives, as an input, information related to each of pieces of communication equipment configuring the network (the nodes of the tree structure). Specifically, for the IoT devices 21 being the transmission sources of the packets, the network information input section 221 inputs the kind and operation environment of each of the IoT devices 21.

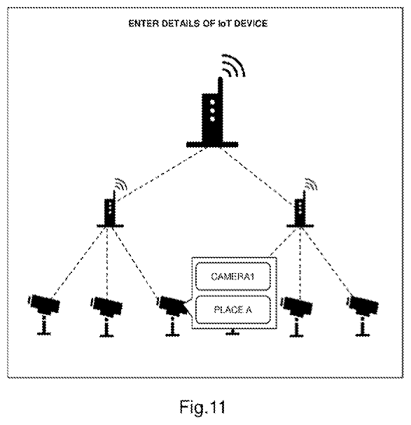

The network information input section 221 may receive, as inputs, the kind and operation environment of each of the IoT devices 21 by using an external storage apparatus such as a USB memory, or may generate GUI information for inputting the information. For example, the network information input section 221 may generate GUI information as that illustrated in FIG. 11 and displays the GUI information on a liquid crystal monitor or the like via the display section 203. The operator inputs the kind (the model name, the product name, and/or the like) and operation environment (the place, the time period, and/or the like) of each of the IoT devices 20 included in the network.

For the packet forwarding nodes (the gateways 22 and the router 23), the network information input section 221 receives, as an input, spec information of each of the packet forwarding nodes. More specifically, the network information input section 221 inputs information related to the specification and capability related to packet forwarding of each of the forwarding nodes.

For example, information associating the product name and/or the like of each forwarding node and the spec information of the forwarding node is stored in the storage section 205 in advance. In this state, the network information input section 221 generates such GUI information that a product name is selectable for each of the forwarding nodes configuring the network and displays the GUI information on a liquid crystal monitor or the like via the display section 203. As described above, the network information input section 221 may refer to the information stored in the storage section 205 to obtain the spec information corresponding to a product input from the operator.

The spec information describes information such as the number of buffers included in the forwarding node, the buffer capacity, a cycle of reading out a packet stored in the buffers, and the like. These pieces of information define the performance of the forwarding node (packet forwarding capability).

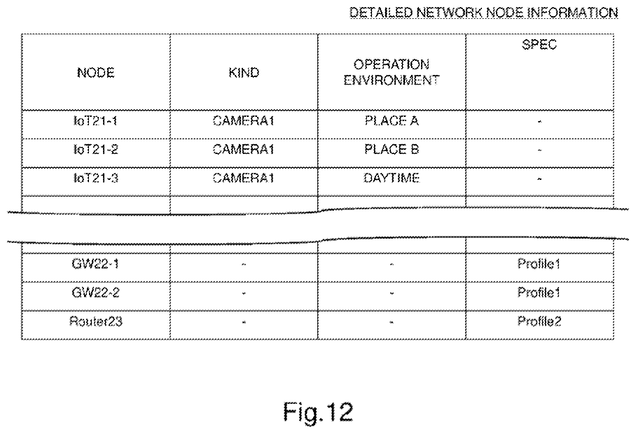

The information related to each of the nodes included in the network, the information being obtained by the network information input section 221, is stored in the storage section 205 as “detailed network node information” (see FIG. 12).

Note that, in FIG. 12, the spec of each of the forwarding nodes (the gateways and the router) is described in a configuration file (profile). In the example in FIG. 12, the profiles of two gateways 22-1 and 22-2 are the same, and this indicates that the two gateways have equivalent packet forwarding capabilities.

The description is turned back to FIG. 4. The simulation execution section 222 is means for using the information obtained by the network information input section 221, to simulate packet forwarding in the network thus input.

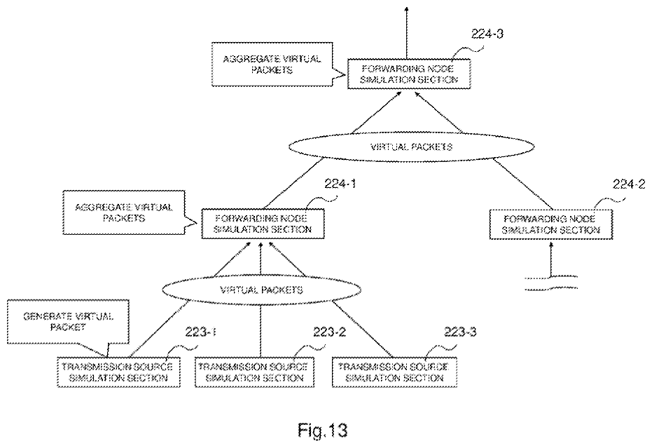

Specifically, in the network managed by the tree structure, the simulation execution section 222 assigns the transmission source simulation section 223 to each of the leaf nodes and the forwarding node simulation section 224 to each of the internal nodes and the root node. For example, in the examples in FIGS. 8 and 10, the transmission source simulation sections 223 and the forwarding node simulation sections 224 are assigned to corresponding nodes of the tree structure representing the network, as illustrated in FIG. 13. In FIG. 13, illustration of the transmission source simulation section 223 connected to a forwarding node simulation section 224-2 is omitted.

The simulation execution section 222 inputs a label corresponding to the transmission source for simulation and a random number (seed value), to the transmission source simulation section 223.

The simulation execution section 222 refers to detailed network node information and traffic pattern generation model management information stored in the storage section 205, to select the label which is to be input to the transmission source simulation section 223. For example, in the example in FIG. 13, a transmission source simulation section 223-1 is assumed to simulate an IoT device 21-1. In this case, it is found, by referring to the detailed network node information illustrated in FIG. 12, that the IoT device 21-1 corresponds to CAMERA 1 placed in the place A.

By referring to the traffic pattern generation model management information illustrated in FIG. 7, the label corresponding to “CAMERA 1” as the kind and “place A” as the operation environment is “L01”. In view of this, the simulation execution section 222 inputs the label L01 and a random number (seed value) to the transmission source simulation section 223-1. Detailed operations of the transmission source simulation section 223 that has received the label and the random number will be described later.

The simulation execution section 222 inputs a configuration file (profile) to the forwarding node simulation section 224. Specifically, the simulation execution section 222 refers to detailed network node information as that illustrated in FIG. 12, to specify the profile to be configured in each forwarding node simulation section 224.

For example, in the example in FIG. 13, the transmission source simulation section 224-1 is assumed to simulate the gateway 22-1. In this case, it is found, by referring to the detailed network node information illustrated in FIG. 12, that the profile of the gateway 22-1 is Profile 1.

The simulation execution section 222 inputs Profile 1 to the forwarding node simulation section 224-1. Detailed operations of the forwarding node simulation section 224 that has obtained the configuration file (profile) will be described later.

The simulation execution section 222 notifies each of the nodes of the network managed using the tree structure, of the place of the connection destination (parent node; upper node) of the node. Specifically, the simulation execution section 222 notifies each of the nodes, of pointer information indicating the location of the upper node and the like. In this notification, the simulation execution section 222 notifies the root node (a node having no parent node) of this (that the node is a root node).

The transmission source simulation section 223 is means for simulating the operations of the IoT device 21 being the packet transmission source. As described above, the transmission source simulation section 223 is assigned to each of the leaf nodes of the tree structure. The transmission source simulation section 223 uses the traffic pattern generation model generated at the time of being in the learning mode, to reproduce the traffic pattern from the IoT device 21.

Specifically, the transmission source simulation section 223 reads, from the storage section 205, the traffic pattern generation model corresponding to the label obtained from the simulation execution section 222. For example, in the above-described example, the IoT device 21-1 simulates the operations of “CAMERA 1” installed in the “place A”, and hence the traffic pattern generation model “M01” is read out with reference to FIG. 7.

Furthermore, the transmission source simulation section 223 inputs a random number (seed value) to the traffic pattern generation model thus read out, to obtain traffic (for example, packet size) from the traffic pattern generation model.

When the packet size obtained from the traffic pattern generation model is not “0”, the transmission source simulation section 223 transmits, as a “virtual packet”, information including the time point (system time point) at which the packet size is obtained and the packet size to the upper forwarding node simulation section 224. Note that, as described above, the entity of such a virtual packet is information related to a time point and a packet size, and hence the information amount of the virtual packet itself is extremely small.

The transmission source simulation section 223 assigned to each of the packet transmission sources (IoT devices 21) of the tree structure repeats operations as those described above in a prescribed sampling cycle. As a result, to the forwarding node simulation section 224 corresponding to the parent node of the IoT device 21, the virtual packet is transmitted in a traffic pattern of transmission from the IoT device 21 simulated by the each of the transmission source simulation section 223.

For example, in FIG. 13, in a case where the transmission source simulation section 223-1 generates the traffic pattern illustrated in FIG. 6A, a virtual packet including such information (time point, packet size) as to reproduce the traffic pattern illustrated in FIG. 6A is transmitted to the forwarding node simulation section 224-1.

Similarly, in a case where the transmission source simulation section 223-2 generates the traffic pattern illustrated in FIG. 6B, a virtual packet including such information (time point, packet size) as to reproduce the traffic pattern illustrated in FIG. 6B is transmitted to the forwarding node simulation section 224-1.

As described above, the transmission source simulation section 223 simulates the packet transmission operations of the IoT device 21 assumed to be placed in an actual environment, in accordance with the traffic pattern generation model generated at the time of being in the learning mode.

The forwarding node simulation section 224 is means for simulating operations of a forwarding node (for example, a corresponding one of the gateways 22 and the router 23). The forwarding node simulation section 224 is assigned to each of the root node and the internal nodes of the tree structure. The forwarding node simulation section 224 simulates the packet forwarding operations in accordance with the configuration file (profile) obtained from the simulation execution section 222.

Specifically, the forwarding node simulation section 224 rearranges virtual packets obtained from child nodes (the transmission source simulation sections 223 and the forwarding node simulation sections 224), in chronological order (in the order according to the time points included in the virtual packets). The forwarding node simulation section 224 thereafter stores each virtual packet in a buffer. More accurately, the forwarding node simulation section 224 subtracts the packet size described in the virtual packet from the buffer capacity described in the obtained profile.

In a case where the buffer capacity remaining after the subtraction is positive, the forwarding node simulation section 224 determines that the buffer has available space and stores in the buffer the next virtual packet among those arranged in chronological order (subtracts the packet size from the buffer capacity). In contrast, in a case where the buffer capacity remaining after the subtraction is zero (or negative), the forwarding node simulation section 224 determines that the buffer has no available space and discards (drops) the subsequent virtual packets.

The forwarding node simulation section 224 transmits each virtual packet stored in the buffer, to the forwarding node simulation section 224 being the parent node, in the order from the virtual packet corresponding to the earliest time point, in the cycle (timing) described in the profile. In this case, the forwarding node simulation section 224 adds the packet size described in the virtual packet, to the buffer capacity (increases available space in the buffer).

The forwarding node simulation section 224-3 corresponding to the root node (the router 23) passes, to the output section 204, a virtual packet read out from the buffer in a similar manner to that described above.

As described above, the forwarding node simulation section 224 simulates the packet forwarding operations of the forwarding node (for example, the corresponding one of the gateways 22 and the router 23), in accordance with the configuration file (profile). More specifically, the forwarding node simulation section 224 aggregates the virtual packets transmitted from child nodes, in terms of time point and size, and forwards the aggregated virtual packets to the node in the subsequent stage. Specifically, each transmission source simulation section 223 transmits a virtual packet to the forwarding node simulation section 224 corresponding to the parent node. The forwarding node simulation section 224 forwards the virtual packets, based on a setting in a predetermined configuration file.

The output section 204 is means for outputting a packet (virtual packet) generated by the packet generation section 202, to an external apparatus. The output section 204 may output the generated virtual packet to an external apparatus such as a liquid crystal monitor.

The output section 204 may analyze the performance at a specific location in the network and output the result of the analysis to an external apparatus. For example, the output section 204 may calculate throughput of the router 23 serving as the exit of the network and output the calculated throughout as the result of the analysis to the external apparatus. Alternatively, the output section 204 may calculate information such as an average packet size, a packet transmission interval, or the like and output the result of the calculation to the external apparatus.

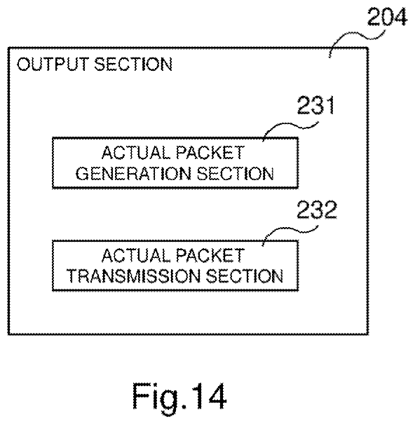

The output section 204 may transmit a real packet (actual packet) to a real network. FIG. 14 is a diagram illustrating an example of an inner configuration of the output section 204 according to the first example embodiment. As illustrated in FIG. 14, in a case where the actual packet is transmitted to the actual network, the output section 204 includes an actual packet generation section 231 and an actual packet transmission section 232.

The actual packet generation section 231 is means for generating an actual packet from a virtual packet. Note that, as described above, the virtual packet includes information of a time point and a packet size and includes no other information. The actual packet generation section 231 generates an actual packet including a header (an IP header, a TCP header, or the like) and payload so that the actual packet has the packet size included in the virtual packet.

In this operation, the actual packet generation section 231 may use a predetermined value as information, such as the IP address and/or the port number, necessary for header generation, or may generate the information in accordance with a prescribed rule. The actual packet generation section 231 also calculates a checksum included in the TCP header or the like, to prevent a contradiction from occurring for data stored in the payload.

The actual packet transmission section 232 transmits the actual packet generated by the actual packet generation section 231, to an actual network (for example, an Ethernet (registered trademark) cable connected to a real router or the like).

Next, operations of the information processing apparatus 10 according to the first example embodiment will be described.

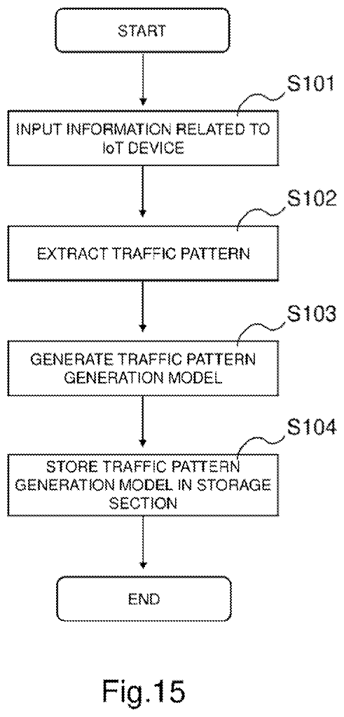

FIG. 15 is a flowchart illustrating an example of operations of the information processing apparatus 10 according to the first example embodiment in a learning mode.

The information processing apparatus 10 receives an input of information related to the IoT device 20 being a packet transmission source (step S101).

The information processing apparatus 10 obtains a traffic flow flowing from the IoT device 20 to a network (a network in an actual environment) and extracts a traffic pattern to be a learning target (step S102).

The information processing apparatus 10 generates a traffic pattern generation model, based on the extracted traffic pattern (step S103).

The information processing apparatus 10 assigns a label to the generated traffic pattern generation model and stores the resultant in the storage section 205 (step S104).

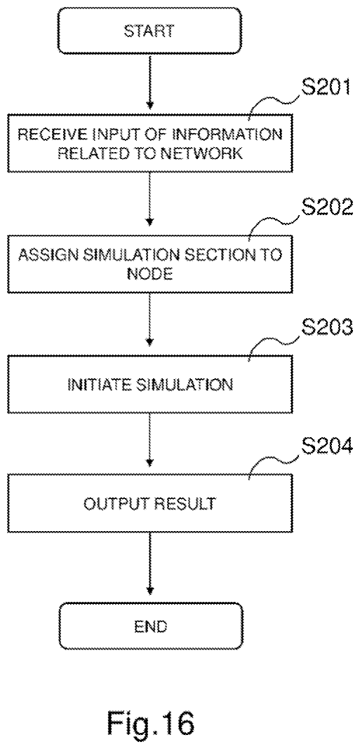

FIG. 16 is a flowchart illustrating an example of operations of the information processing apparatus 10 according to the first example embodiment in the simulation mode.

The information processing apparatus 10 receives an input of information related to a network to simulate (step S201). Specifically, details of the configuration of the network and communication equipment to be used are input.

The information processing apparatus 10 manages the obtained configuration of the network in a tree structure and assigns simulation sections (the transmission source simulation sections 223 and forwarding node simulation sections 224) to the respective nodes of the tree structure (step S202).

The information processing apparatus 10 performs necessary configuration for each of the simulation sections (for example, inputs a label or the like to each of the transmission source simulation sections 223 and configures a profile in each of the forwarding node simulation sections 224) and thereafter initiates simulation (step S203).

The information processing apparatus 10 outputs a simulation result to an external apparatus (step S204).

As described above, the information processing apparatus 10 according to the first example embodiment performs learning (unsupervised learning) on traffic flowing from the IoT device 20 operating in a real system to a network, and generates a traffic pattern generation model that reproduces the traffic. The information processing apparatus 10 then simulates packet forwarding of the network to which the IoT device 20 is connected, by using the generated traffic pattern generation model. It is possible, when the performance of the network (for example, the throughput of the edge router 23) is lower than what is expected, based on the result of the simulation, to change the configuration of the network and check the performance again.

Although the traffic pattern of the IoT device 20 varies by operation environment, a traffic pattern generation model is generated in consideration of such a difference in operation environment and the like in the first example embodiment, and hence it is possible to perform more accurate determination related to whether or not the network configuration is suitable.

As a technique for reproducing traffic of the IoT device 20, there exist other techniques than that of the disclosure of the present application. For example, there is a manual approach in which an operating person configures a parameter so as to reproduce traffic of the IoT device 20, to generate a packet, based on a probability distribution according to the parameter. In the manual approach, great effort is required in order to configure a parameter for each different operation environment, which is hence impractical.

Although an optimal network configuration is defined once, the number of IoT devices 20 may increase or decrease in some cases due to a business grow of the business operator or the like. In this case, it is necessary to determine how to change an existing network. Using the information processing apparatus 10 according to the first example embodiment allows such determination to be easily performed. Specifically, it is only required to change the number of IoT devices 20 of the network configuration as that illustrated in FIG. 8 to be input to the information processing apparatus 10 and then execute simulation. For example, in a case of increasing the number of IoT devices 20 (in a case of scale-up), whether or not the performance of the network after the scale-up is sufficient is checked. In contrast, in a case of decreasing the number of IoT devices 20 (in a case of scale-out), whether or not the performance of the network after the scale-out is excess is checked.

As described above, the information processing apparatus 10 according to the first example embodiment uses a traffic pattern generation model to simulate packet forwarding in a network. Hence, it is possible to easily verify an influence in a case where the number of the IoT devices 20 is scaled or a case where the configuration of the network is changed.

Note that the specifying section 102 is a module that performs the operations of the simulation execution section 222 and the transmission source simulation section 233. Specifically, the video of the simulation execution section 222 referring to traffic pattern generation model management information corresponds to “based on virtual traffic in the traffic pattern generation model” of the specifying section 102. The operation of the transmission source simulation section 233 selecting a traffic pattern generation model stored in the storage section 205, based on a label obtained from the traffic pattern generation model management information corresponds to “specifying traffic for an output of a traffic pattern generation model”. The packet generation section 202 generates a packet, based on traffic (a set of virtual packets) characterized by the specifying section 102.

### Second Example Embodiment

Next, a second example embodiment will be described in detail with reference to the drawings.

The first example embodiment presupposes that the performance of the link between the IoT device 21 and the gateway 22 and the performance of the link between the gateway 22 and the router 23 are ideal. Specifically, it is presupposed that a packet (virtual packet) transmitted from the IoT device 21 instantaneously arrives at the gateway 22 with no delay. It is also presupposed that all packets transmitted from the IoT device 21 arrive at the gateway 22.

However, the performance of a link in an actual environment is not so ideal, and transmit packets are delayed and are lost (packet loss) at a certain rate.

In the second example embodiment, a description will be given of a case where characteristics of a link as those described above are modeled and a virtual packet transmitted from the IoT device 21 is transmitted to the gateway 22 or the like through the link obtained through the modeling. In other words, according to the second example embodiment, it is possible to, by reproducing the characteristics of a link, obtain a simulation result in a state closer to a real environment.

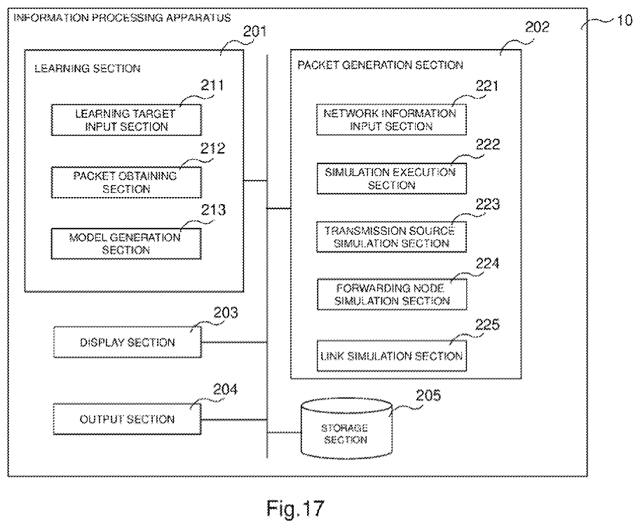

FIG. 17 is a diagram illustrating an example of a processing configuration (processing modules) of an information processing apparatus 10 according to the second example embodiment. With reference to FIG. 17, a link simulation section 225 is added to the information processing apparatus 10 of the first example embodiment.

A description will be mainly given of differences between the first and second example embodiments below.

The link simulation section 225 is means for simulating the characteristics of a link of a network subject to simulation. More specifically, the link simulation section 225 simulates link characteristics between nodes (the IoT devices 21, the gateways 22, and the router 23). A virtual packet transmitted from the transmission source simulation section 223 is transmitted from the transmission source simulation section 223 to the forwarding node simulation section 224 via the link simulation section 225.

The link simulation section 225 reproduces network characteristics of the link. Specifically, the simulation execution section 222 inputs a configuration file (also referred to as a link profile below) to the link simulation section 225.

In the link profile, communication quality (for example, delay, bit rate, loss rate, and the like) representing the network characteristics of the link is described. The link simulation section 225 executes transmission control for the received virtual packet according to the communication quality.

For example, the link simulation section 225 determines the transmission time point of the received virtual packet according to Expression (1) below, for transmission to the node in the subsequent stage (the gateway 22 or the like).

[Math. 1]

T_{P}←T_{P}+D_{C}+L_{P}÷BR (1)

In Expression (1), T_{P} denotes a scheduled packet generation time, D_{C} denotes queuing delay, L_{P} denotes a packet length (packet size), and BR denotes a bit rate. For the queuing delay and the bit rate, values described in the link profile are used.

Alternatively, the link simulation section 225 discards the received virtual packet according to the loss rate described in the link profile.

As described above, the link simulation section 225 performs adjustment of packet transmission interval and stochastic occurrence of packet loss according to the communication quality described in the link profile.

For the generation of the link profile, an administrator can use a result of measurement in an actual environment to generate a link profile. The information processing apparatus 10 or another apparatus may measure the communication quality and generates a link profile, based on the result of the measurement. Alternatively, in a case where the communication quality changes depending on time period, a change pattern of the communication quality may be used as a scenario to generate a link profile. In this case, it is only required to generate a link profile including communication quality for each time period.

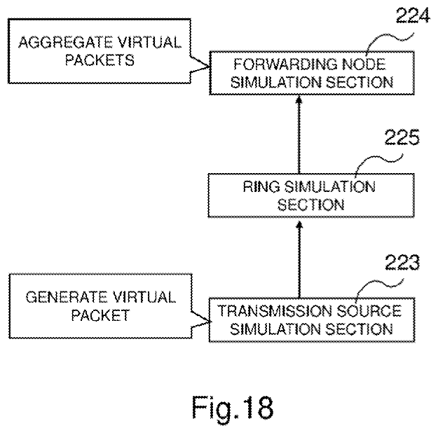

The simulation execution section 222 arranges the link simulation section 225 between nodes of the tree structure. For example, the simulation execution section 222 arranges the link simulation section 225 between the transmission source simulation section 223 and the forwarding node simulation section 224 as illustrated in FIG. 18.

The simulation execution section 222 inputs a link file corresponding to the position of the link simulation section 225 thus arranged, to the corresponding link simulation section 225. The simulation execution section 222 thereafter activates the modules (the transmission source simulation section 223, the forwarding node simulation section 224, and the link simulation section 225), to simulate packet forwarding in the network.

As described above, the information processing apparatus 10 according to the second example embodiment reproduces the link characteristics between nodes by using the link simulation section 225. This consequently allows the information processing apparatus 10 to output a more accurate simulation result.

### Third Example Embodiment

Next, a third example embodiment will be described in detail with reference to the drawings.

In the third example embodiment, application of the information processing apparatus 10 described above will be described. By using the information processing apparatus 10, it is possible to provide, to a business operator with little knowledge related to a network, a network configuration suitable for the specification of the network presupposed by the business operator.

In the following description, a business operator who desires to construct a network in a factory or the like is referred to as a “client”, and a business operator who proposes an optimal network configuration to the client is referred to as a “consultant”.

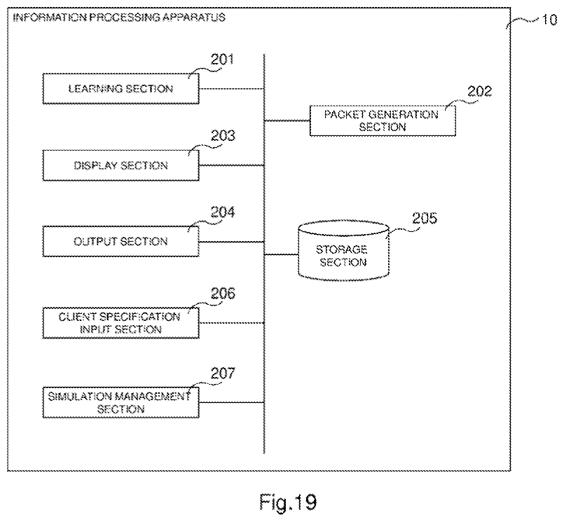

FIG. 19 is a diagram illustrating an example of a processing configuration (processing module) of an information processing apparatus 10 according to the third example embodiment. The information processing apparatus 10 according to the third example embodiment is configured by adding a client specification input section 206 and a simulation management section 207 to the information processing apparatus 10 according to the first and second example embodiments.

When a consultant receives a request of a proposal for an optimal network configuration from a client, the consultant obtains, from the client, the specification related to a network of the client (referred to as a client network specification below). Specifically, the consultant interviews the client about the presupposed schematic configuration of the network, the number of IoT devices 20 included in the network, performance related to the throughput at the exit of the network, and the like.

The client specification input section 206 is means for inputting a result obtained by the consultant through the interview. Specifically, the client specification input section 206 receives, as an input, the specification of a network subject to simulation. For example, the client specification input section 206 generates information for displaying a GUI as that illustrated in FIGS. 9, 11, and 20 and the like and displays the information on a liquid crystal monitor or the like via the display section 203.

The client specification input section 206 stores the information obtained through the GUI or the like (the client network specification) in the storage section 205. Note that, before and/or after the obtaining of a required specification related to the network of the client, the consultant performs learning of the traffic pattern of each of the IoT devices 20 included in the network of the client. Specifically, the information processing apparatus 10 executes the processing in the learning mode to perform learning of the traffic pattern related to the IoT device 20 scheduled to be used in the network of the client and generate a traffic pattern generation model.

Note that, regarding the traffic pattern learning for the IoT device 20, the learning is not needed in a case where a traffic pattern generation model of the IoT device 20 obtained through learning of the network of another client in the past can be reused. In other words, by dealing with a number of tasks, the frequency of the consultant reusing the traffic patterns of various IoT devices 20 increases.

When the learning of the traffic pattern of the IoT device 20 and the inputting of the client network specification are completed, the information processing apparatus 10 initiates calculation of an optimal network configuration for the client. Specifically, the simulation management section 207 refers to the schematic network configuration included in the client network specification, to obtain a network template corresponding to the schematic configuration.

For example, as illustrated in FIG. 21, the storage section 205 stores network templates corresponding to the respective schematic network configurations. The profile of communication equipment described in each network template is also associated in advance for management.

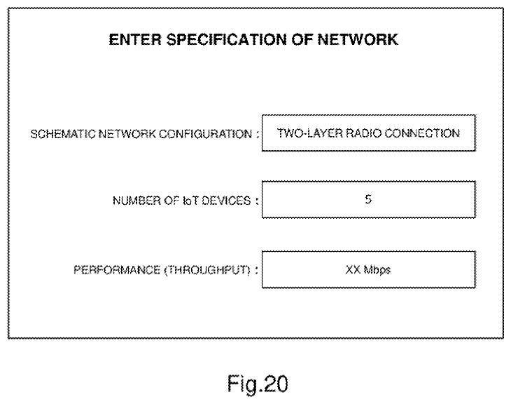

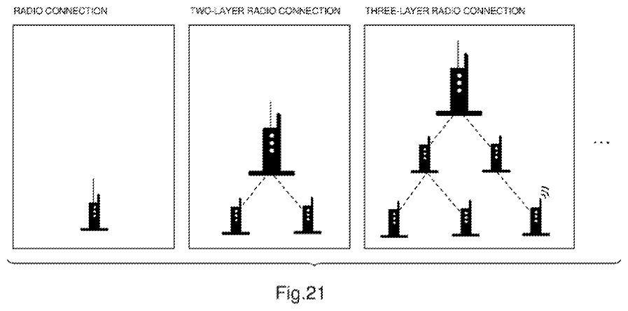

In the example in FIG. 20, “two-layer radio connection” is included in the client network specification, and hence the template illustrated in the middle in FIG. 21 is selected.

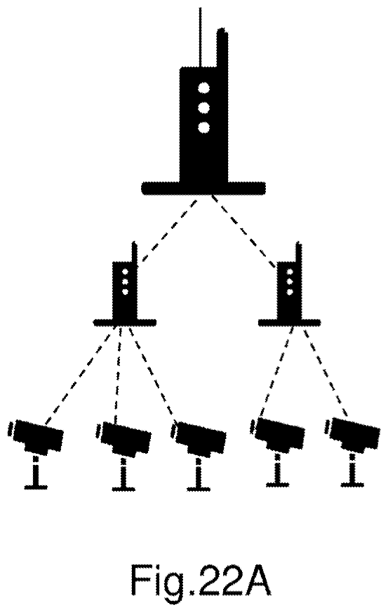

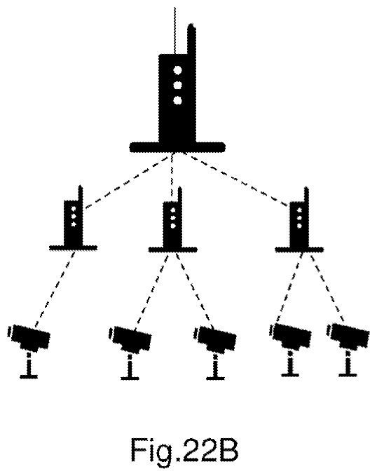

The simulation management section 207 then reflects the number of IoT devices 20 included in the client network specification in the network template. In the example in FIG. 20, five IoT devices 20 are connected to the network, and hence a network configuration as that illustrated in FIG. 22A is obtained.

The simulation management section 207 passes the network template in which the number of IoT devices 20 operating in the network of the client is reflected, to the packet generation section 202, to indicate execution of simulation.

The packet generation section 202 outputs virtual packets generated by the method described in the example embodiments, to the simulation management section 207. The simulation management section 207 determines whether or not the performance of the network satisfies the performance (for example, the throughput) included in the client network specification, based on the obtained virtual packets.

When the performance of the network is satisfied, the simulation management section 207 determines that the network configuration passed to the packet generation section 202 is an optimal network configuration for the client. On the other hand, when the performance of the network is not satisfied, the simulation management section 207 indicates the packet generation section 202 to increase the number of nodes included in the network template and execute simulation, based on the network configuration after the increase.

For example, the simulation management section 207 passes the network configuration illustrated in FIG. 22B to the packet generation section 202, to indicate execution of simulation.

The simulation management section 207 repeats processing as that described above to find a network configuration satisfying the performance (throughput) described in the client network specification.

The information processing apparatus 10 outputs the network configuration thus found. Specifically, a configuration diagram as that illustrated in FIG. 22B may be stored in a USB memory or the like or may be displayed on a liquid crystal monitor or the like via the display section 203. The consultant proposes the found network configuration as an optimal network configuration for the client.

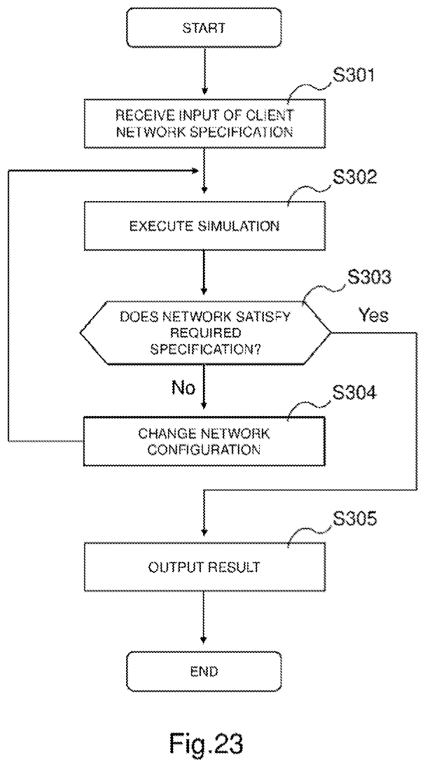

FIG. 23 is a flowchart illustrating an example of operations of an information processing apparatus 10 according to the third example embodiment.

The information processing apparatus 10 receives an input of a client network specification from the consultant (step S301).

The information processing apparatus 10 executes simulation of packet forwarding, based on the client network specification (step S302).

The information processing apparatus 10 determines whether or not the network satisfies a request of the client, based on the result of the simulation (step S303). In a case where the network does not satisfy the request of the client (No at the branch of step S303), the information processing apparatus 10 changes the configuration of the network (step S304) and executes simulation again.

In a case where the network satisfies the request of the client (Yes at the branch of step S303), the information processing apparatus 10 determines that the network is an optimal network and outputs the determination result (step S305).

Note that the number of the IoT devices 20 to be used in the client network specification is input in the third example embodiment, but the kinds of the IoT devices 20 or applications to be used may be input. In the description, the performance at the exit connected to an external network is evaluated based on virtual packets output from the packet generation section 202. However, actual packets may be passed to an external network to evaluate the performance. The external network in this case may be a test environment of the client or a real network.

As described above, in the third example embodiment, the information processing apparatus 10 repeats simulation of packet forwarding until a network configuration suitable for the input specification of the network is obtained. As a result, the consultant can propose an optimal network configuration to the client by using the information processing apparatus 10.

### Fourth Example Embodiment

Next, a fourth example embodiment will be described in detail with reference to the drawings.

In the fourth example embodiment, verification of the load of a network performed by using the above-described information processing apparatus 10 will be described. More specifically, in a case where the number of packet transmission sources (the IoT devices 20) included in an actual network is increased (scaling up the IoT devices 20), the information processing apparatus 10 can be used for the use of investigating an increase in load of equipment connected to the network.

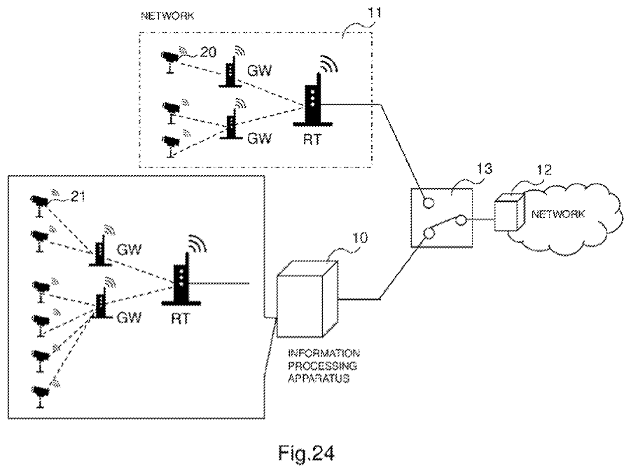

For example, as illustrated in FIG. 24, consider a case where a network 11 and a router 12 are connected. In this case, how much the load of the router 12 increases in a case where the number of IoT devices 20 included in the network 11 is increased, is verified by using the information processing apparatus 10.

The information processing apparatus 10 performs learning of the traffic pattern of each of the IoT devices 20 from the network 11 in operation, to generate a traffic pattern generation model. Subsequently, an operator or the like disconnects the connection between the network 11 and the router 12 by using a switch 13 and connects the information processing apparatus 10 and the router 12.

The information processing apparatus 10 replicate the generated traffic pattern generation model to simulate the state in which the number of packet transmission sources in the network 11 is increased, and transmits an actual packet toward the router 12. As a result, the number of IoT devices 20 being the packet transmission sources virtually increases, and the number of packets arriving at the router 12 increases.

The operator can investigate, by investigating an increase in the load of the router 12, an influence on the router 12 in a case of scaling up the packet transmission sources (the IoT devices 21) in the network 11.

As described above, the load of the system can be verified by using the information processing apparatus 10.

### Fifth Example Embodiment

Next, a fifth example embodiment will be described in detail with reference to the drawings.

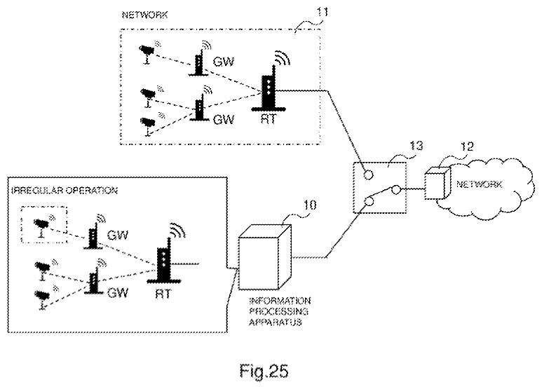

In the fifth example embodiment, a description will be given of a case of verifying whether or not security of a system is functioning correctly, by using the information processing apparatus 10. In the fifth example embodiment, as illustrated in FIG. 25, the configuration of the network 11 is reproduced in an information processing apparatus 10.

Subsequently, the information processing apparatus 10 causes at least one or more of packet transmission sources (IoT devices 20) to perform an irregular operation. Specifically, the information processing apparatus 10 selects one or more of a plurality of traffic pattern generation models corresponding to the IoT device(s) 20 and changes the selected traffic pattern generation model.

For example, the information processing apparatus 10 changes the selected traffic pattern generation model to have a probability distribution obtained by inversion in magnitude or a predetermined irregular probability distribution. Subsequently, the information processing apparatus 10 executes the operations described in the first example embodiment, to generate a traffic flow including packets transmitted from the irregular IoT device(s) 20 and transmit the traffic flow to the router 12.

The operator verifies whether or not the router 12 having received the flow indicates a suspicious behavior.

As described above, the security of the system can be verified by using the information processing apparatus 10.

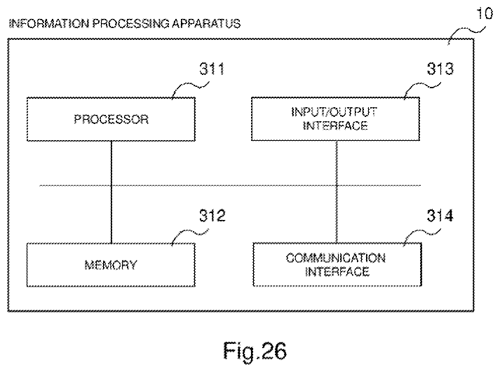

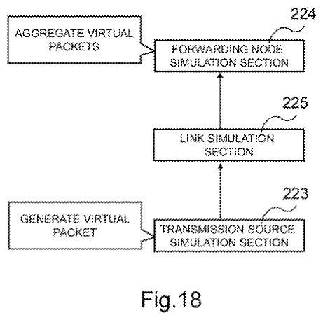

Next, hardware of the information processing apparatus 10 will be described. FIG. 26 is a diagram illustrating an example of a hardware configuration of the information processing apparatus 10.

The information processing apparatus 10 is a computer and includes a configuration illustrated in FIG. 26. For example, the information processing apparatus 10 includes a processor 311, a memory 312, an input/output interface 313, a communication interface 314, and the like. Constituent elements such as the processor 311 are connected to each other with an internal bus or the like, and are configured to be capable of communicating with each other.

Note that the configuration illustrated in FIG. 26 is not to limit the hardware configuration of the information processing apparatus 10. The information processing apparatus 10 may include hardware not illustrated, or need not include the input/output interface 313 as necessary. The number of processors 311 and the like included in the information processing apparatus 10 is not to be limited to the example illustrated in FIG. 26, and for example, a plurality of processors 311 may be included in the information processing apparatus 10.

The processor 311 is, for example, a programmable device such as a central processing unit (CPU), a micro processing unit (MPU), and a digital signal processor (DSP). Alternatively, the processor 311 may be a device such as a field programmable gate array (FPGA) and an application specific integrated circuit (ASIC). The processor 311 executes various programs including an operating system (OS).

The memory 312 is a random access memory (RAM), a read only memory (ROM), a hard disk drive (HDD), a solid state drive (SSD), or the like. The memory 312 stores an OS program, an application program, and various pieces of data.

The input/output interface 313 is an interface of a display apparatus and an input apparatus (not illustrated). The display apparatus is, for example, a liquid crystal display or the like. The input apparatus is, for example, an apparatus that receives user operation, such as a keyboard and a mouse.

The communication interface 314 is a circuit, a module, or the like that performs communication with another apparatus. For example, the communication interface 314 includes a network interface card (NIC), a radio communication circuit, or the like.

The functions of the information processing apparatus 10 are implemented by various processing modules. Each of the processing modules is, for example, implemented by the processor 311 executing a program stored in the memory 312. The program can be recorded on a computer readable storage medium. The storage medium can be a non-transitory storage medium, such as a semiconductor memory, a hard disk, a magnetic recording medium, and an optical recording medium. In other words, the present invention can also be implemented as a computer program product. The program can be updated through downloading via a network, or by using a storage medium storing a program. In addition, the processing module may be implemented by a semiconductor chip.

### Example Alterations

Note that the operations and the like of the information processing apparatus 10 described in each of the example embodiments are merely examples, and are not to limit the operations and the like of the information processing apparatus 10. For example, each of the processing modules (the learning section 201, the packet generation section 202, and the like) included in the information processing apparatus 10 may be implemented in separate apparatuses. In other words, the disclosure of the present application may be implemented as a system including a learning means, a packet generation means, and the like.

For example, the information processing apparatus 10 may output, to an external apparatus, not only packets from the exit (edge router) of a network for which simulation is executed but also packets forwarded from a forwarding node in the middle. For example, in the example in FIG. 8, virtual packets transmitted from the gateway 22-1 and a gateway 22-2 to the router 23 may be output to an external apparatus. Through such an operation, performance evaluation for each of pieces of communication equipment configuring the network can be performed (for example, the throughput of each pieces of equipment can be evaluated). As a result, the administrator or the like can easily find a bottleneck and the like of the network system.

In the example embodiments, the description has been given that a virtual packet includes only information of a time point and a packet size, but a virtual packet may include other kinds of information. For example, a virtual packet may include an IP address, a port number, and the like. Alternatively, a virtual packet may include a sequence number. In this case, since the information processing apparatus 10 can recognize the existence of a packet that has been discarded, from the sequence number, the information processing apparatus 10 can count the number of packets dropped by the gateway 22 and the router 23 and hence calculate the packet loss rate.

In the example embodiment, the description has been given that the security of the system in a case where the IoT device 20 being a packet transmission source performs an irregular operation can be verified. However, any of the forwarding nodes (the gateways 22 and the router 23) may perform such an irregular operation instead. This makes it possible to verify a system operation (influence on the system) in a case where the gateways 22 and the like is faulty or performs a degeneration operation.

The information processing apparatus 10 can also output a generated traffic pattern generation model to external equipment. Specifically, the information processing apparatus 10 may store the generated traffic pattern generation model and information (kind and operation environment) based on which the model is generated, in association with each other in a database server or the like. The traffic pattern generation model stored in the database server may be shared by a plurality of information processing apparatuses 10. Alternatively, the traffic pattern generation model and related information of the model may be sold to outside parties.

In the example embodiments, the processing capability of the network is enhanced by increasing the number of forwarding nodes (for example, the gateways 22) in the searching of a network configuration suitable for a client network specification. However, the information processing apparatus 10 may perform the searching of an optimal network configuration by gradually enhancing the capability (for example, the buffer size or the like described in the profile) of each node with a fixed configuration of the network.

In the example embodiments, the description has been given of the case of reproducing the characteristics of a link by using a link profile. However, such link characteristics may be reproduced by modeling using a hidden Markov model described in the first example embodiment. Specifically, learning of traffic flowing from the gateway 22 to the router 23 or the like may be performed to use, as the link simulation section 225, a learning model that can provide the result.

Alternatively, the forwarding node simulation section 224 may configure such a profile as to execute a bandwidth control or the like, to execute simulation of packet forwarding closer to real.

In the example embodiments, the description has been given of the case of verifying the performance of the router 12 that directly receives traffic transmitted from the network of a business operator, and the like. However, the point to be verified may be another apparatus. For example, in a case of investigating the uplink performance of private LTE, the traffic up to an IoT gateway may be simulated by the information processing apparatus 10 of the disclosure of the present application, and actual packets may be used for the traffic from the IoT gateway to a base station.

Alternatively, in a case where the IoT device 20 investigates the load of the server 30 accessed by the IoT device 20, packet forwarding to a point immediately previous to the server 30 may be simulated by the information processing apparatus 10 of the disclosure of the present application, and packets transmitted to the server 30 may be actual packets.

Alternatively, in a case of investigating a network load from each of a plurality of instances of private LTE to a core network, packet forwarding to base stations (more specifically EPCs) is simulated by a plurality of information processing apparatuses 10, and actual packets may be transmitted from each of the information processing apparatuses 10 to the core network.

A network that can be provided according to the disclosure of the present application may be a wireless local area network (LAN) system, such as wireless fidelity (WiFi (registered trademark)) or a mobile communication system, such as Long Term Evolution (LTE).

The disclosure of the present application is applicable to any network such as a corporate intranet, a factory intranet, or a home intranet. In this case, packet forwarding to an in-corporate router, an in-factory router, or an in-home router is subject to simulation.

The target of learning of a traffic pattern by the information processing apparatus 10 are not limited to the IoT device 20 and may be a terminal such as a smartphone. In a case where a network is terminated at IoT devices, robots, and/or the like, traffic of specific devices (devices desired to be scaled-up or scaled-out) may be collected for learning to generate a pattern of the traffic. Alternatively, in a case where a network is terminated at terminals such as personal computers and/or smartphones, traffic of specific users (heavy users or general users) may be collected for learning in a carrier network of the like to generate a pattern of the traffic.

In the example embodiments, in a case where the information processing apparatus 10 is used for the purpose of consultant, whether or not the performance of a network satisfies a demand from the client is determined, and the operations of the information processing apparatus 10 are changed according to the result of the determination. However, the information processing apparatus 10 may output, every time the determination is made, to what degree a network configuration subject to simulation satisfies the demand from the client or to what degree the network configuration does not satisfy the demand from the client. For example, when the demand for the throughput from the client is 10 Mbps and the result of the throughput in simulation is 5 Mbps, the information processing apparatus 10 calculates that the degree of sufficiency related to the demand from the client is 50%. By providing the degree of sufficiency related to the demand from the client, to the client through the consultant, the information processing apparatus 10 can lead the client to a compromise for the performance, a reconsideration of the network configuration, and the like. Alternatively, the information processing apparatus 10 may output the configuration subject to simulation and the value of throughput in the simulation, to cause the operator to select whether to change the configuration and perform simulation again.

In the example embodiments, the description has been given of the case where a simulation-target network configuration is managed by using a tree structure and the simulation section is assigned to each node, to execute simulation. However, packet forwarding may be simulated by another method. Specifically, consider a case where the simulation execution section 222 generates a virtual packet at the root node as an actual packet. In this case, the simulation execution section 222 calculates a path toward the leaf node being the transmission source that has generated the virtual packet (the list of node numbers included from the root node to the leaf node). The leaf node generates one virtual packet in which a size and a time point are configured in accordance with a traffic pattern generation model and outputs the virtual packet to an intermediate node (upper node) immediately previous to the leaf node in the path. The intermediate node buffers a received packet and sorts the buffered packets, and also outputs the first packet in the buffer to the intermediate node immediately previous in the path. The simulation management section 207 repeats such operations, and upon arrival to the root node, an actual packet is generated as soon as the time has reached the generation time point for the first virtual packet in the buffer as an actual packet. As described above, packet forwarding in the network may be simulated through recursive processing. By using such recursive processing, simulation of packet forwarding can be performed with a small number of processes. Specifically, when a network configuration is given, packets generated from each transmission source and the propagation of the packets are calculated, and the node where the traffic aggregate (for example, a gateway) is assigned to have a function of generating actual packets. As a result, it is possible to pretend just as if traffic is generated from a number of transmission sources, with a small number of processes.

In the plurality of flowcharts and sequence diagrams used in the example embodiments, a plurality of processes (processing) are described in order; however, the order of execution of the processes executed in each example embodiment is not limited to the described order. In each example embodiment, the illustrated order of processes can be changed as far as there is no problem with regard to processing contents, such as a change in which respective processes are executed in parallel, for example. The above-described example embodiments can be combined as long as the contents do not contradict each other.

The whole or part of the example embodiments disclosed above can be described as in the following supplementary notes, but are not limited to the following.

### [Supplementary Note 1]

An information processing apparatus (10, 100) including: a model generation section (101, 213) configured to perform learning of a traffic pattern of a terminal (20) to generate a traffic pattern generation model reproducing the traffic pattern; and a packet generation section (202) configured to generate, based on the traffic pattern generation model, a virtual packet for simulating packet forwarding of a packet transmitted from the terminal (20) in a network.

### [Supplementary Note 2]

The information processing apparatus (10, 100) according to supplementary note 1, wherein the virtual packet includes information on a time point and information on a packet size.

### [Supplementary Note 3]

The information processing apparatus (10, 100) according to supplementary note 1 or 2, wherein the network subject to the simulation is managed using a tree structure, the packet generation section (202) includes a transmission source simulation section (223) assigned to a leaf node of the tree structure and a forwarding node simulation section (224) assigned to a root node and an internal node of the tree structure, and the transmission source simulation section (223) is configured to transmit the virtual packet to the forwarding node simulation section (224) corresponding to a parent node.

### [Supplementary Note 4]

The information processing apparatus (10, 100) according to supplementary note 3, wherein the forwarding node simulation section (224) is configured to forward the virtual packet based on a setting in a predetermined configuration file.

### [Supplementary Note 5]

The information processing apparatus (10, 100) according to supplementary note 3 or 4, wherein the packet generation section (202) further includes a link simulation section (225) configured to simulate characteristics of a link of the network, and the virtual packet is transmitted from the transmission source simulation section (223) to the forwarding node simulation section (224) via the link simulation section (225).

### [Supplementary Note 6]

The information processing apparatus (10, 100) according to any one of supplementary notes 3 to 5, further including: an input section (206) configured to input a specification of the network subject to the simulation; and a management section (207) configured to repeat simulation of the packet forwarding until a network configuration suitable for the input network specification is obtained.

### [Supplementary Note 7]

A packet generation method including, in an information processing apparatus (10, 100): performing learning of a traffic pattern of a terminal (20) to generate a traffic pattern generation model reproducing the traffic pattern; and generating, based on the traffic pattern generation model, a virtual packet for simulating packet forwarding of a packet transmitted from the terminal (20) in a network.

### [Supplementary Note 8]

The packet generation method according to supplementary note 7, wherein the virtual packet includes information on a time point and information on a packet size.

### [Supplementary Note 9]

The packet generation method according to supplementary note 7 or 8, wherein the network subject to the simulation is managed using a tree structure, the information processing apparatus (10, 100) includes a transmission source simulation section (223) assigned to a leaf node of the tree structure and a forwarding node simulation section (224) assigned to a root node and an internal node of the tree structure, wherein the packet generation method further includes transmitting by the transmission source simulation section (223) the virtual packet to the forwarding node simulation section (224) corresponding to a parent node.

### [Supplementary Note 10]

The packet generation method according to supplementary note 9, wherein the forwarding node simulation section (224) forwards the virtual packet based on a setting in a predetermined configuration file.

### [Supplementary Note 11]

The packet generation method according to supplementary note 9 or 10, wherein the information processing apparatus (10, 100) further includes a link simulation section (225) configured to simulate characteristics of a link of the network, and the packet generation method further includes transmitting the virtual packet from the transmission source simulation section (223) to the forwarding node simulation section (224) via the link simulation section (225).

### [Supplementary Note 12]

The packet generation method according to any one of supplementary notes 9 to 11, further including: inputting a specification of the network subject to the simulation; and repeating simulation of the packet forwarding until a network configuration suitable for the input network specification is obtained.

### [Supplementary Note 13]

A program for causing a computer (311) installed in an information processing apparatus (10, 100) to execute: processing for performing learning of a traffic pattern of a terminal (20) to generate a traffic pattern generation model reproducing the traffic pattern; and processing for generating, based on the traffic pattern generation model, a virtual packet for simulating packet forwarding of a packet transmitted from the terminal (20) in a network.

### [Supplementary Note 14]

The program according to supplementary note 13, wherein the virtual packet includes information on a time point and information on a packet size.

### [Supplementary Note 15]

The program according to supplementary note 13 or 14, wherein the network subject to the simulation is managed using a tree structure, the information processing apparatus (10, 100) includes a transmission source simulation section (223) assigned to a leaf node of the tree structure and a forwarding node simulation section (224) assigned to a root node and an internal node of the tree structure, wherein the program causes the computer to further execute processing for transmitting by the transmission source simulation section (223) the virtual packet to the forwarding node simulation section (224) corresponding to a parent node.

### [Supplementary Note 16]

The program according to supplementary note 15, wherein the forwarding node simulation section (224) is configured to forward the virtual packet based on a setting in a predetermined configuration file.

### [Supplementary Note 17]

The program according to supplementary note 15 or 16, wherein the information processing apparatus (10, 100) further includes a link simulation section (225) configured to simulate characteristics of a link of the network, and the program causing the computer to further execute processing for transmitting the virtual packet from the transmission source simulation section (223) to the forwarding node simulation section (224) via the link simulation section (225).

### [Supplementary Note 18]

The program according to any one of supplementary notes 15 to 17, causing the computer to further execute: processing for inputting a specification of the network subject to the simulation; and processing for repeating simulation of the packet forwarding until a network configuration suitable for the input network specification is obtained.

Note that the disclosures of the cited literature in the citation list are intended to be incorporated herein by reference. Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

This application claims priority based on JP 2019-168014 filed on Sep. 17, 2019, the entire disclosure of which is incorporated herein.

### INDUSTRIAL APPLICABILITY

The present invention contributes to easy finding of a network configuration according to the characteristics of a terminal to be connected.

### REFERENCE SIGNS LIST

10, 100 Information Processing Apparatus
11 Network
12, 23 Router
13 Switch
14 Terminal
15 Base Station
16 WiFi (registered trademark) Router
17 In-corporation Router
20, 21, 21-1 to 21-6 IoT Device
22, 22-1, 22-2 Gateway
30 Server
101, 213 Model Generation Section
102 Specifying Section
201 Learning Section
202 Packet Generation Section
203 Display Section
204 Output Section
205 Storage Section
206 Client Specification Input Section
207 Simulation Management Section
211 Learning Target Input Section
212 Packet Obtaining Section
221 Network Information Input Section
222 Simulation Execution Section
223, 223-1 to 223-3 Transmission Source Simulation Section
224, 224-1 to 224-3 Forwarding Node Simulation Section
225 Link Simulation Section
231 Actual Packet Generation Section
232 Actual Packet Transmission Section
311 Processor
312 Memory
313 Input/Output Interface
314 Communication Interface

What is claimed is:

1. An information processing apparatus comprising:
a memory storing instructions; and
one or more processors configured to execute the instructions to:
generate a traffic pattern generation model, based on learning of a traffic pattern of a terminal; and
specify traffic for an output of the traffic pattern generation model, based on virtual traffic in the traffic pattern generation model.

2. The information processing apparatus according to claim 1, wherein the one or more processors are configured to generate a packet, based on the specified traffic.

3. The information processing apparatus according to claim 2, wherein the one or more processors are configured to execute the instructions to function as:
a transmission source simulation module assigned to a leaf node of a tree structure that manages a configuration of a network; and
a forwarding node simulation module assigned to a root node and an internal node of the tree structure,
wherein the transmission source simulation module is configured to transmit a virtual packet output from the traffic pattern generation model to the forwarding node simulation module corresponding to a parent node.

4. The information processing apparatus according to claim 3, wherein the forwarding node simulation module is configured to forward the virtual packet, based on a setting in a predetermined configuration file.

5. The information processing apparatus according to claim 3, wherein the one or more processors are configured to execute the instructions to function as a link simulation module configured to simulate characteristics of a link of the network, and
the virtual packet is transmitted from the transmission source simulation module to the forwarding node simulation module via the link simulation module.

6. The information processing apparatus according to claim 3, wherein the one or more processors are configured to execute the instructions to:
input a specification of the network; and
repeat the forwarding of the packet until a network configuration suitable for the input network specification is obtained.

7. A packet generation method in an information processing apparatus including a memory storing instructions and one or more processors configured to execute the instructions, the packet generation method comprising:
generating a traffic pattern generation model, based on learning of a traffic pattern of a terminal; and
specifying traffic for an output of the traffic pattern generation model, based on virtual traffic in the traffic pattern generation model.

8. The packet generation method according to claim 7, further comprising generating a packet, based on the specified traffic.

9. The packet generation method according to claim 8, wherein the one or more processors are configured to execute the instructions to function as:
a transmission source simulation module assigned to a leaf node of a tree structure that manages a configuration of a network; and
a forwarding node simulation module assigned to a root node and an internal node of the tree structure,
wherein the packet generation method further comprises transmitting, by transmission source simulation module, a virtual packet output from the traffic pattern generation model to the forwarding node simulation module corresponding to a parent node.

10. The packet generation method according to claim 9, wherein the packet generation method further comprises forwarding, by the forwarding node simulation module, the virtual packet, based on a setting in a predetermined configuration file.

11. The packet generation method according to claim 9, wherein the one or more processors are configured to execute the instructions to function as a link simulation module configured to simulate characteristics of a link of the network, and
the packet generation method further comprises transmitting the virtual packet from the transmission source simulation module to the forwarding node simulation module via the link simulation module.

12. The packet generation method according to claim 9, further comprising:
inputting a specification of the network; and
repeating the forwarding of the packet until a network configuration suitable for the input network specification is obtained.

13. A system comprising:
a memory storing instructions; and
one or more processors configured to execute the instructions to:
generate a traffic pattern generation model, based on learning of a traffic pattern of a terminal; and
specify traffic for an output of the traffic pattern generation model, based on virtual traffic in the traffic pattern generation model.

14. The system according to claim 13, wherein the one or more processors are configured to generate a packet based on the specified traffic.

15. The system according to claim 14, wherein the one or more processors are configured to execute the instructions to function as:
a transmission source simulation module assigned to a leaf node of a tree structure that manages a configuration of a network; and
a forwarding node simulation module assigned to a root node and an internal node of the tree structure,
wherein the transmission source simulation module is configured to transmit a virtual packet output from the traffic pattern generation model to the forwarding node simulation module corresponding to a parent node.

16. The system according to claim 15, wherein the forwarding node simulation module is configured to forward the virtual packet, based on a setting in a predetermined configuration file.

17. The system according to claim 15, wherein the one or more processors are configured to execute the instructions to function as a link simulation module configured to simulate characteristics of a link of the network, and
the virtual packet is transmitted from the transmission source simulation module to the forwarding node simulation module via the link simulation module.

18. The system according to claim 15, wherein the one or more processors are configured to execute the instructions to:
input a specification of the network; and
repeat the forwarding of the packet until a network configuration suitable for the input network specification is obtained.

19-24. (canceled)
